(19) United States
(12) Patent Application Publication
(10) Pub. No.: US 2020/0128800 A1
(43) Pub. Date: Apr. 30, 2020

(54) System of Cultivating Aquatic Product and Plant

(71) Applicant: TAIWAN WATER RECYCLE TECHNOLOGY CO., LTD., TAICHUNG CITY (TW)

(72) Inventor: Chi-Tse KUO, TAICHUNG CITY (TW)

(21) Appl. No.: 16/171,628

(22) Filed: Oct. 26, 2018

(51) Int. Cl. A01K 63/04; A01C 23/00; A01G 33/00

(52) U.S. Cl. CPC A01K 63/045; A01K 63/042; A01G 33/00; A01C 23/008; A01K 63/047

(57) ABSTRACT

A system of cultivating aquatic product and plant contains: a cultivation tank, a blower configured to pump air into the cultivation tank, a first pump, a protein separator, a first ultrafiltration unit, a collection chamber configured to hold bubbled fluid, a second ultrafiltration unit configured to maintain mucus and solid suspension substances in water, a first gathering bucket configured to hold cloudy high-protein concentration fluid, a second gathering bucket, a Nano-filtration unit, a recycle tank configured to hold the recyclable water from the Nano-filtration unit, and a second pump used to pump the recyclable water back to the cultivation tank. The first pump includes a first tube and a second tube. The protein separator includes a hollow cylinder, a bubble generation unit, an outlet pipe, and a bubble pipe. The first ultrafiltration unit includes multiple ultrafiltration films equidistantly. The Nano-filtration unit includes multiple Nano-filtration films.

### CROSS REFERENCE TO RELATED APPLICATIONS

The present application is a divisional application of U.S. patent application Ser. No. 15/150,294, entitled “method and system of cultivating aquatic product and plant” filed on May 9, 2016, which is incorporated herein by reference.

### FIELD OF THE INVENTION

The present invention relates to a system of processing cultivation water, and more particularly to a system of cultivating aquatic product and plant which enhances recycle efficiency of recyclable water and separates high-protein concentration fluid from cultivation wastewater so as to provide nutrient to aquatic product and plant.

### DESCRIPTION OF THE PRIOR ART

Water treatment equipment for recirculating aquaculture is disclosed in U.S. Ser. No. 14/317,803 by inventor, and it pumps cultivation water into a cultivation tank, and the cultivation water is aerated in the cultivation tank by way of aeration equipment so as to provide oxygen, and an overflow water pipe connects with a purifier, such that the water is filtered, purified, and flows back to the cultivation tank.

To reduce concentration of ammonia and nitrogen, a protein separator is configured to replace a nitrifying bacteria layer, such that mucus (such as protein) and aerosols are eliminated from water by using bubbles, and a plurality of filtration films are not blocked by the mucus. On the other hands, oxygen in the water is increased.

However, the water treatment equipment has defects as follows:

1. Most part of the cultivation water is drained as separating protein from the cultivation water by mean of the protein separator, so at least 10% of cultivation water has to be extra added into the cultivation tank.

2. The water treatment equipment is capable of spraying clean water to wash a plurality of filtration films, but the cultivation water becomes fouled after the clean water flows into the filtration tank, so some of the cultivation water is drained because suspension solids increase, thus reducing recyclable efficiency.

In addition, cultivation wastewater from the protein separator contains ammonia, nitrogen, and phosphorus to contaminate the cultivation water.

The present invention has arisen to mitigate and/or obviate the afore-described disadvantages.

### SUMMARY OF THE INVENTION

The primary objective of the present invention is to provide a system of cultivating aquatic product and plant which enhances recycle efficiency of recyclable water and separates high-protein concentration fluid from cultivation wastewater so as to provide nutrient to aquatic product and plant.

To obtain the above objective, a system of cultivating aquatic product and plant provided by the present invention is fixed between a cultivation tank and a plant factory, and the system contains: a cultivation tank, a blower, a first pump, a protein separator, a first ultrafiltration unit, a collection chamber, a second ultrafiltration unit, a first gathering bucket, a second gathering bucket, a Nano-filtration unit, a recycle tank, and a second pump.

The cultivation tank accommodates cultivation water.

The blower is configured to pump air into the cultivation tank and to provide dissolved oxygen to the cultivation water.

The first pump includes a first tube located below the cultivation water, and the first pump includes a second tube extending toward a bottom of the cultivation tank and communicating with the first tube.

The protein separator includes a hollow cylinder communicating with the second tube, a bubble generation unit fixed in the hollow cylinder, an outlet pipe extending toward the cultivation tank from the hollow cylinder, and a bubble pipe, wherein the bubble generation unit draws spray gas and mixes the spray gas with water in the hollow cylinder so as to produce bubbles to attach protein, bait, excreta and molecule colloids on the bubbles, and the bubbles are pushed upwardly so as to form bubbled fluid, then the bubbled fluid drains through the bubble pipe so as to separate bubbles of the bubbled fluid from water of the bubbled fluid, thereafter the water flows downwardly back to the cultivation tank from the outlet pipe.

The collection chamber is configured to hold the bubbled fluid flowing through the bubble pipe and to form cultivation wastewater.

The cultivation wastewater is pumped into each of the plurality of ultrafiltration units, and each ultrafiltration unit includes a plurality of ultrafiltration films equidistantly arranged and configured to maintain mucus and solid suspension substances in the water so as to separate filtered fluid from cloudy high-protein concentration fluid.

The first gathering bucket is configured to hold the cloudy high-protein concentration fluid used as organic fertilizer nutrients in a plant factory or biological bait broth to aquaculture industry.

The second gathering bucket is configured to hold clear high-protein concentration fluid.

The Nano-filtration unit is connected with one side of the first ultrafiltration unit and accommodates the filtered fluid, wherein the Nano-filtration unit includes multiple Nano-filtration films is configured to eliminate ammonia nitrogen in the filtered fluid so as to produce recyclable water with amino acids, and the water is maintained to form the clear high-protein concentration fluid;

The recycle tank is configured to hold the recyclable water from the Nano-filtration unit.

The second pump is used to pump the recyclable water back to the cultivation tank.

### BRIEF DESCRIPTION OF THE DRAWINGS

FIG. 1 is a diagram view showing the assembly of a system of cultivating aquatic product and plant according to a preferred embodiment of the present invention.

FIG. 2 is a flow chart of a method of cultivating aquatic product and plant according to a preferred embodiment of the present invention.

FIG. 3 is a diagram view showing the assembly of a part of system of cultivating aquatic product and plant according to the preferred embodiment of the present invention.

### DETAILED DESCRIPTION OF THE PREFERRED EMBODIMENTS

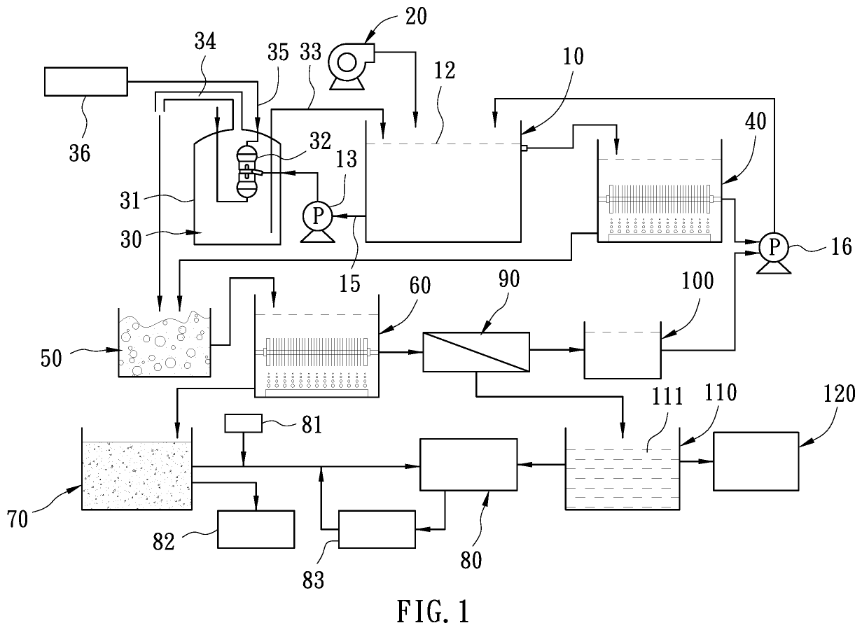

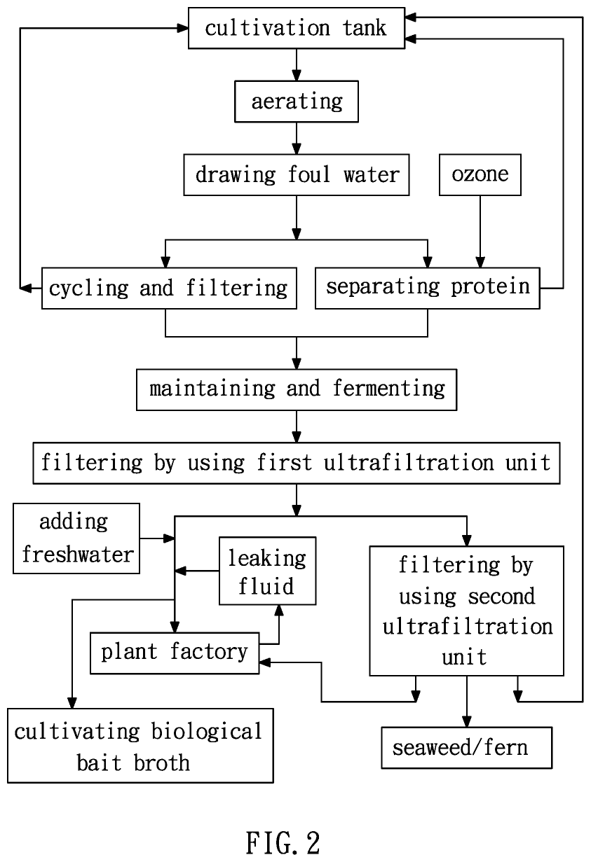

With reference to FIGS. 1 and 2, a method of cultivating aquatic product and plant according to a preferred embodiment of the present invention comprises steps of:

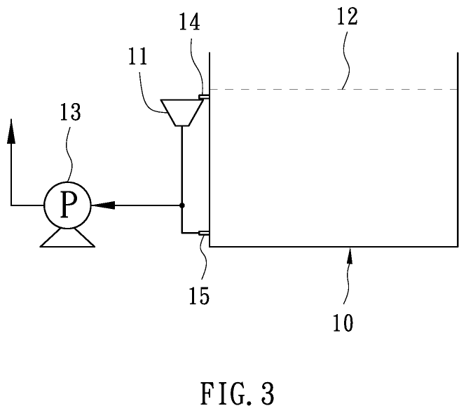

(A) Preparing a cultivation tank 10 which includes a discharge cavity 11 (as shown in FIG. 3) in which cultivation water 12 is accommodated, wherein a PH value and a solid concentration of the cultivation water 12 are adjusted, and edible salt and chemical salt are added in the cultivation water 12 so as to comply with quality requirement of the cultivation water 12.

(B) Aerating the cultivation water 12 in the cultivation tank 10 so as to provide dissolved oxygen to the cultivation water 12, wherein a blower 20 is mounted on one side of the cultivation tank 10 so as to pump air into the cultivation tank 10 and to drain residue feeding and excreta out of the cultivation tank 10 by using the discharge cavity 11.

(C) Drawing overflow water in a top of the cultivation tank 10 and foul water in a bottom of the cultivation tank 10 into a protein separator 30 and a first ultrafiltration unit 40 in a flat disc shape. Referring further to FIG. 3, the foul water is drawn to the protein separator 30 via a first pump 13, wherein the first pump 13 includes a first tube 14 adjacent to the discharge cavity 11 and includes a second tube 15 extending toward the bottom of the cultivation tank 10 and communicating with the first tube 14.

The protein separator 30 includes a hollow cylinder 31 communicating with the second tube 15, a bubble generation unit 32 fixed in the hollow cylinder 31, an outlet pipe 33 extending toward the cultivation tank 10 from a bottom of the hollow cylinder 31, and a bubble pipe 34 secured in a top of the hollow cylinder 31.

The first ultrafiltration unit 40 includes a plurality of ultrafiltration films equidistantly arranged and disclosed in TW Patent Nos. 1312767, 1318233, and 1348389, hence recyclable water forms after water is filtered by the plurality of ultrafiltration films from the cultivation tank 10. Thereafter, the recyclable water is drawn back to the cultivation tank 10 by a second pump 16, and concentrated waste fluid is maintained and discharges to a collection chamber 50.

Spray gas 35 is drawn into the bubble generation unit 32 and mixes with the water so as to produce bubbles to attach protein, bait, excreta and molecule colloids (such as faded shells or fish scale) on the bubbles, and the bubbles are pushed upwardly so as to form bubbled fluid, then the bubbled fluid flows into the collection chamber 50 through the bubble pipe 34 so as to separate bubbles of the bubbled fluid from water of the bubbled fluid. Thereafter, the water flows downwardly back to the cultivation tank 10 from the outlet pipe 33.

Furthermore, the spray gas 35 mixes with ozone 36 of high concentration so as to sterilize bacteria in the cultivation water 12, and the protein separator 30 is used as an ozone reaction chamber configured to adjust inflow of the ozone 36, such that excessive ozone oxidizes ammonia and nitrite in the water to nitrate nitrogen or nitrogen, and the protein separator 30 eliminates ammonia and nitrogen.

The method of the present invention further comprises steps of:

(D) Collecting the bubbled fluid from the protein separator 30 and the concentrated waste fluid from the first ultrafiltration unit 40 (or the foul water produced by washing the plurality of ultrafiltration films) into the collection chamber 50 so as to generate cultivation wastewater with high ammonia and suspension concentration.

(E) Pumping the cultivation wastewater into a second ultrafiltration unit 60 in a flat disc shape and filtering the cultivation wastewater by using a plurality of ultrafiltration films of the second ultrafiltration unit 60, wherein mucus, solid suspension substances and macromolecules in water are maintained by the plurality of ultrafiltration films so as to separate filtered fluid and cloudy high-protein concentration fluid.

(F) Discharging the cloudy high-protein concentration fluid into a first gathering bucket 70, wherein the cloudy high-protein concentration fluid contains protein, amino acids, fat, and carbohydrate which exist in a concentrated liquid form or a paste form, hence the cloudy high-protein concentration fluid mixes into culture soil so as to produce organic fertilizer nutrients in a plant factory 80. Alternatively, the cloudy high-protein concentration fluid is diluted by adding freshwater 81 so as to form biological bait broth 82 to aquaculture industry.

(G) Pumping the filtered fluid filtered by the plurality of ultrafiltration films of the second ultrafiltration unit 60 into a Nano-filtration unit 90 so as to filter the filtered fluid again, wherein multiple Nano-filtration films eliminate ammonia nitrogen, dissolved organic substances, and nitrite slat in the filtered fluid, thus producing the recyclable water with amino acids. Thereafter, the recyclable water is stored in a recycle tank 100 and is maintained by the multiple Nano-filtration films so as to form clear high-protein concentration fluid 111 which is held by a second gathering bucket 110. The clear high-protein concentration fluid 111 is used as culture fluid 120 to hydroponic plants, seaweed, or fern.

(H) Flowing the recyclable water into the cultivation tank 10 from the recycle tank 100.

To provide nutrient solution to the plant factory 80, concentration of the cloudy high-protein concentration fluid in step (F) to step (G) is adjusted, for example, adding the freshwater 81 into the first gathering bucket 70 and the second gathering bucket 110 so as to dilute the concentration of the cloudy high-protein concentration fluid required by the plant factory 80.

Furthermore, the plant factory 80 drains leaking fluid 83 out of a bench after cultivation, and the leaking fluid 83 flows back to the first gathering bucket 70 so as to mix with the cloudy high-protein concentration fluid, thus reducing water consumption and cultivation cost.

Thereby, the method of the present invention drains the bubbled fluid from the protein separator 30, filters the cultivation water in the cultivation tank 10 so as to maintain the concentrated waste fluid, and collects and accommodates spray water sprayed to the plurality of ultrafiltration films so as to produce the cultivation wastewater. Thereafter, the cultivation wastewater is filtered and separated by the plurality of ultrafiltration films so as to form the cloudy high-protein concentration fluid and the filtered fluid, and the filtered fluid is filtered by the Nano-filtration films (UF films) so as to produce the recyclable water in compliance with the quality requirement of the cultivation water, thus saving water consumption and cultivation cost and decreasing environmental pollution.

Preferably, the cloudy or clear high-protein concentration fluid is used as the nutrient solution for culturing seaweed or fern in the plant factory 80.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A system of cultivating aquatic product and plant being fixed between a cultivation tank and a plant factory and comprising:
a cultivation tank in which cultivation water is accommodated;
a blower configured to pump air into the cultivation tank and to provide dissolved oxygen to the cultivation water;
a first pump including a first tube located below the cultivation water, and the first pump including a second tube extending toward a bottom of the cultivation tank and communicating with the first tube;
a protein separator including a hollow cylinder communicating with the second tube, a bubble generation unit fixed in the hollow cylinder, an outlet pipe extending toward the cultivation tank from the hollow cylinder, and a bubble pipe;
a first ultrafiltration units including a plurality of ultrafiltration films equidistantly arranged, and the cultivation water being pumped into the first ultrafiltration units;
a collection chamber configured to hold bubbled fluid flowing through the bubble pipe and to form cultivation wastewater; characterized in that
a second ultrafiltration unit into which the cultivation wastewater is pumped, and the second ultrafiltration unit being configured to maintain mucus and solid suspension substances in water so as to separate filtered fluid from cloudy high-protein concentration fluid;
a first gathering bucket configured to hold the cloudy high-protein concentration fluid used as organic fertilizer nutrients in the plant factory or biological bait broth to aquaculture industry;
a second gathering bucket configured to hold clear high-protein concentration fluid;
a Nano-filtration unit connected with one side of the second ultrafiltration unit and accommodates the filtered fluid, the Nano-filtration unit includes multiple Nano-filtration films configured to eliminate ammonia nitrogen in the filtered fluid so as to produce recyclable water with amino acids, and the water is maintained to form the clear high-protein concentration fluid;
a recycle tank configured to hold the recyclable water from the Nano-filtration unit; and
a second pump used to pump the recyclable water back to the cultivation tank.

2. The system as claimed in claim 1, wherein the plurality of ultrafiltration units includes the first ultrafiltration unit fixed between the cultivation tank and the second pump so as to filter the cultivation water in the cultivation tank, thus forming the recyclable water; and the plurality of ultrafiltration units also includes a second ultrafiltration unit mounted between the collection chamber and the Nano-filtration unit.
